(19) United States
(12) Patent Application Publication
(10) Pub. No.: US 2018/0290372 A1
(43) Pub. Date: Oct. 11, 2018

(54) A PROCESS OF INCORPORATING EMBOSSED VISUAL EFFECT/SECURITY FEATURE ON A FLEXIBLE SUBSTRATE AND SUBSTRATE/PACKAGE MADE THEREFROM

(71) Applicant: Ashok CHATURVEDI, New Delhi (IN)

(72) Inventor: Ashok CHATURVEDI, New Delhi (IN)

(21) Appl. No.: 15/767,034

(22) PCT Filed: Oct. 9, 2016
(86) PCT No.: PCT/IN2016/050346

§ 371 Date: Apr. 9, 2018

(30) Foreign Application Priority Data
Oct. 9, 2015 (IN) 3250/DEL/2015

(51) Int. Cl. B29C 59/04; B29D 11/00; B41M 1/22; B41M 1/30; B41M 3/00; B41M 3/14; B42D 25/29; B42D 25/425; B44C 1/17; B44F 1/02

(52) U.S. Cl. CPC B29C 59/046; B29D 11/00288; B41M 1/22; B41M 1/305; B41M 3/003; B41M 3/008; B29C 2035/0827; B42D 25/29; B42D 25/425; B44C 1/1729; B44C 1/1733; B44F 1/02; B29D 11/00269; B41M 3/14

(57) ABSTRACT

The present invention describes the use of embossed patterns for producing striking visual patterns and/or security features on the package surface such as holographic images, 3-dimensional patterns, optical patterns, Fresnel lenses, sterling lenses or any similar optical features in registered or unregistered manner on a specified portion on a web, sheet or package. The present invention eliminates intermediate products and processes such as manufacturing and using stamping foils avoiding wastage of carrier films. This result in high speed operation with accurate registration for packaging substrate in web roll form or in sheet form.

### FIELD OF INVENTION

The present invention relates generally to the use of embossed patterns for producing striking visual patterns and/or security features on the package surface such as holographic images, 3-dimensional patterns, optical patterns, Fresnel lenses, sterling lenses or any similar optical features and more particularly to a new and improved method for producing such optical effects in registered or unregistered manner on a specified portion on a web, sheet or package.

### BACKGROUND

In the printing and packaging industry, it is often desired to integrate visual effects on printed package. In many cases, such effects such as holographic images, 3-dimensional patterns, optical patterns, Fresnel lenses, sterling lenses or any similar optical features, are incorporated on the exterior surface of rigid, semi-rigid and flexible package, and other printed packages. In some cases, however, it is not desired to have the optical effects appearing on the entire visible surface of the package. Alternatively, it may be desired to have more than one optical effect on packages, even though at different locations on the package surface. Such visual effects also provide security features to prove authenticity of product/package.

Conventionally, the optical/visual effects are provided on packages via Fresnel lenses, sterling lenses or any other optical pattern over the entire surface of package regardless of the desired space and location. Such uneconomical use of the holographic images, 3-dimensional patterns, optical patterns, Fresnel lenses, sterling lenses or any other optical pattern unnecessarily increases the cost of the entire process.

Holographic images, 3-dimensional patterns, optical patterns, Fresnel lenses, sterling lenses or any similar optical features are usually achieved by hot or cold stamping on the flexible packaging substrates of polymers, woven or non woven fibrous substrates such as papers, for security, tamper evidence or enhancing aesthetics. The optical features are generally required at a particular location on a packaging substrate, registered with respect to some marking or printing already done/to be done on the substrate. It is quite difficult and requires very expensive equipment to transfer the features in registration on hot or cold stamping machines. The Hot or cold stamping foils have a carrier film of PET or BOPP which goes waste after transferring holographic images, 3-dimensional patterns, optical patterns, Fresnel lenses, sterling lenses or any similar optical features on the substrates. The stamping foil for configuring holographic images, optical patterns, Fresnel lenses, sterling lenses or any similar optical features has metalized surface for embossing to have reflective surface which require a process of vacuum metalizing. This process is relatively slow and thus makes the whole process of stamping foil production slow. Transfer by hot or cold stamping foil usually leaves broken edges/burrs on the periphery of holographic images, optical patterns, Fresnel lenses, sterling lenses or any similar optical features. As the stamping foil is manufactured separately it incurs additional cost to the process, which can be obviated.

Moreover, vacuum metallization equipment is very expensive. Furthermore, it is very difficult and expensive to have selective metallization. These metal vaporization technologies typically operate at very high temperatures and vacuums, requiring special attention by operating personnel. The metallization done by vapour deposition has poor scratch resistance and hence requires a clear Lacquer coating and curing, to protect the deposited metal on the surface.

Therefore, there is a need for providing a method for making a decorative substrate with holographic images, optical patterns, Fresnel lenses, sterling lenses or any similar optical features on a predefined portion of the package in a faster and cost efficient way, thereby increasing the aesthetic value of the packaging and which also can be used as a security feature and identification/authentication mark for original product. There is a need in the art to provide a substrate with holographic images, 3-dimensional patterns, optical patterns, Fresnel lenses, sterling lenses or any similar optical features or a combination thereof and a method for making the same, which addresses the problems identified above.

### OBJECT OF THE INVENTION

The present invention offers an innovative process for making packaging substrate to produce packages that addresses all the issues mentioned above in the prior art. The process includes printing of high reflective ink that offers metallic mirror like luster in silver, gold or any other shade. The printing may be done all over the surface of flexible packaging substrate, or at a specified location. The printing includes a defined shape and size, registered with respect to a reference mark, or printing in case the flexible packaging substrate is pre-printed. The operation is performed in roll to roll or in sheet form.

The present invention more particularly provides a process of selective printing in defined shape and size with high reflective ink on a predefined portion of the packaging substrate and registered embossing of Fresnel lenses, sterling lenses or any other type of lens/pattern or a combination thereof, on the predefined portion of the packaging substrate. The packaging substrate may be transparent or opaque.

Another object of the present invention is to provide a package made from a substrate having integrated visual effect/security features as described above, on at least one of its side or faces is disclosed.

### SUMMARY OF THE INVENTION

According to an embodiment of the invention a process of providing selective printing and embossing of visual effect/security features such as Holographic images, Fresnel lenses/sterling lenses etc. on a transparent substrate comprises—

providing a substrate of single layer/multilayer/laminate,
printing on a predefined portion of a desired shape and size with high reflective ink at predefined location on a bottom surface of the transparent substrate,
providing a registered UV or E-beam curable coating patch overlapping the printed predefined portion on the top surface of the substrate,
providing a registered/unregistered embossing of the visual effect/security features on the UV/E-beam curable coating patch, and
curing the UV/E-beam curable coating patch after embossing.

According to another embodiment of the invention a process for providing selective printing and embossing of visual effect/security features such as Holographic images, Fresnel lenses/sterling lenses etc. on an opaque packaging substrate comprises—

providing an opaque packaging substrate,
printing on a predefined portion of a desired shape and size with high reflective ink at predefined location top surface of the opaque substrate,
providing a registered UV or E-beam curable coating patch overlapping the printed predefined portion on the top surface of the substrate,
providing a registered/unregistered embossing of the visual effect/security features on the UV/E-beam curable coating patch, and
curing the UV/E-beam curable coating patch after embossing.

According to a yet another embodiment of the invention, a flexible package made from the transparent or the opaque substrate is provided. The substrates used for making the flexible package incorporates features as mentioned earlier.

These together with the other aspects of the invention, along with the various features of novelty that characterize the invention, are pointed out with particularly in the description, along with the abovementioned summary, annexed hereto and form a part of the invention. For a better understanding of the invention, its operating advantages and the specified object attained by its uses, reference should be made to the accompanying drawings and descriptive matter in which there are illustrated embodiments of the invention.

### BRIEF DESCRIPTION OF THE DRAWINGS

FIG. 1A illustrates prior art of transferring visual effects or lenses or security feature by hot/cold stamping process over a substrate, and

FIG. 1B illustrates the substrate provided with a visual effect/lenses/security feature.

FIG. 2, illustrates flow chart of steps involved in providing the embossed visual/security feature/lenses on a portion of transparent substrate according to first embodiment of the invention.

FIG. 2A, illustrates flow chart of steps involved in providing the visual/security feature on a portion of opaque substrate according to second embodiment of the invention.

FIG. 3, illustrates graphical representation of steps in accordance with FIG. 2 and FIG. 2A.

FIG. 4 and FIG. 4A, illustrates the process of providing visual/security feature on a predefined portion of substrate in web or roll form.

FIG. 5 illustrates a typical package prepared from substrate obtained by the process of present invention having the visual/security feature.

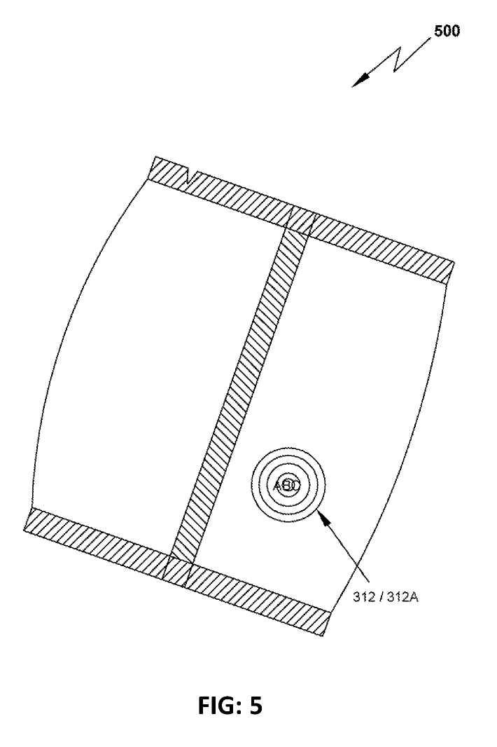

### DETAILED DESCRIPTION

For a thorough understanding of the present invention, reference is made to the following detailed description in connection with the above-mentioned drawings. Although the present invention is described with reference to exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the present invention. Further, it will nevertheless be understood that no limitation in the scope of the invention is thereby intended, such alterations and further modifications in the figures and such further applications of the principles of the invention as illustrated herein being contemplated as would normally occur to one skilled in the art to which the invention relates. Also, it is to be understood that the phraseology and terminology used herein is for the purpose of description and should not be regarded as limiting. Further, reference herein to “one embodiment” or “an embodiment” means that a particular feature, characteristic, or function described in connection with the embodiment is included in at least one embodiment of the invention. Furthermore, the appearances of such phrase at various places herein are not necessarily all referring to the same embodiment. The terms “a” and “an” herein do not denote a limitation of quantity, but rather denote the presence of at least one of the referenced item.

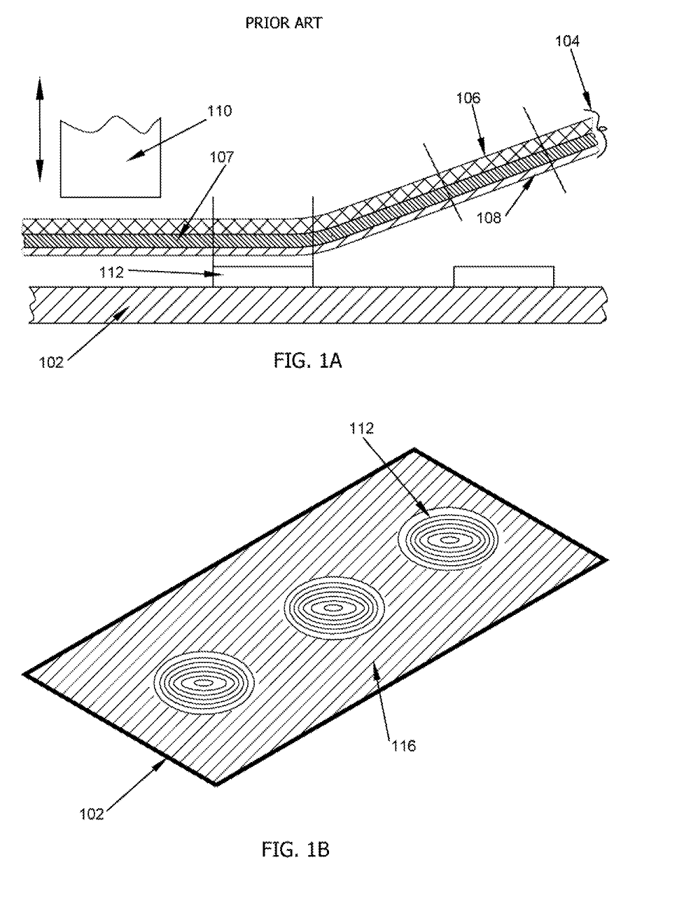

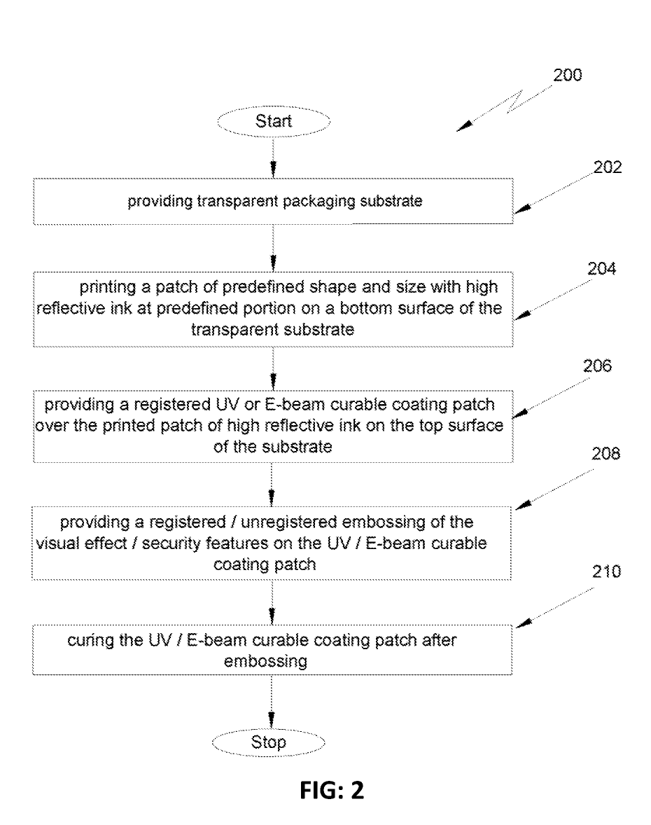

FIG. 1A illustrates a prior art process of hot/cold stamping for providing a visual effect or security feature on a substrate (102). As shown, the substrate (102) is configured to be provided with a visual/security feature. Further, the substrate (102) is provided with the visual/security feature from a stamping foil (104), as mentioned with respect to the background of the present disclosure. The stamping foil (104) includes a carrier film (106), and a decorative layer (108) configured with the carrier layer (106). The stamping foil (104) includes a metallization layer (107) for providing a reflective surface required to get the holographic or any other visual effect obtained by reflection of incident light. As shown, the stamping foil (104) is moved close to the substrate (102) in such a way, that a cold/hot stamping punch (110) stamps and transfers a portion of the stamping foil (104) on to the surface of substrate (102) to configure the visual/security feature on the substrate (102). FIG. 1B further illustrates the substrate (102) provided with the visual/security feature (112). The substrate (102) is further provided with a protective clear lacquer or curable coating (116). As described earlier, the carrier film (106) of the stamping foil (104) is scrapped after stamping operation.

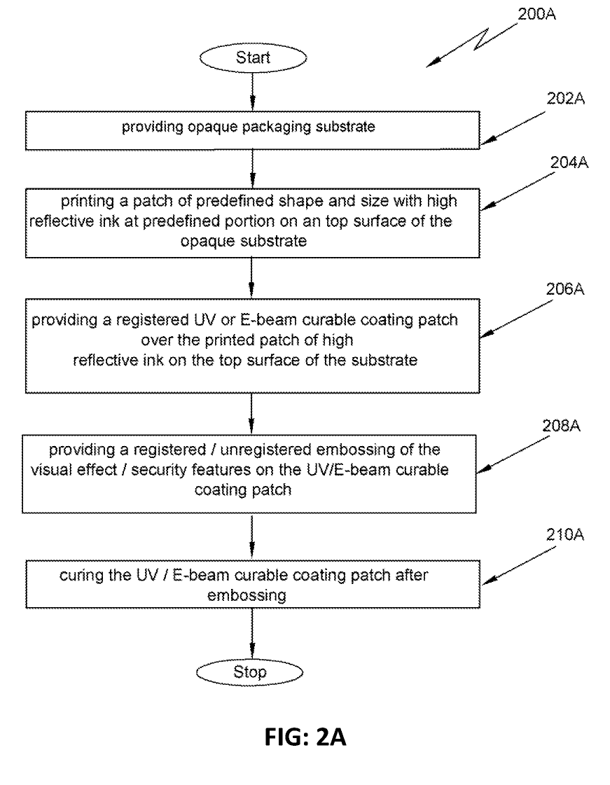

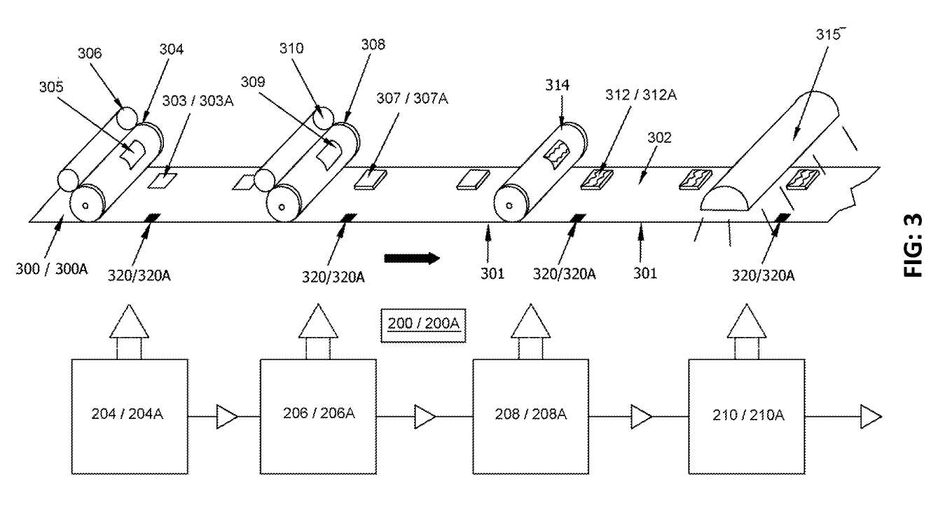

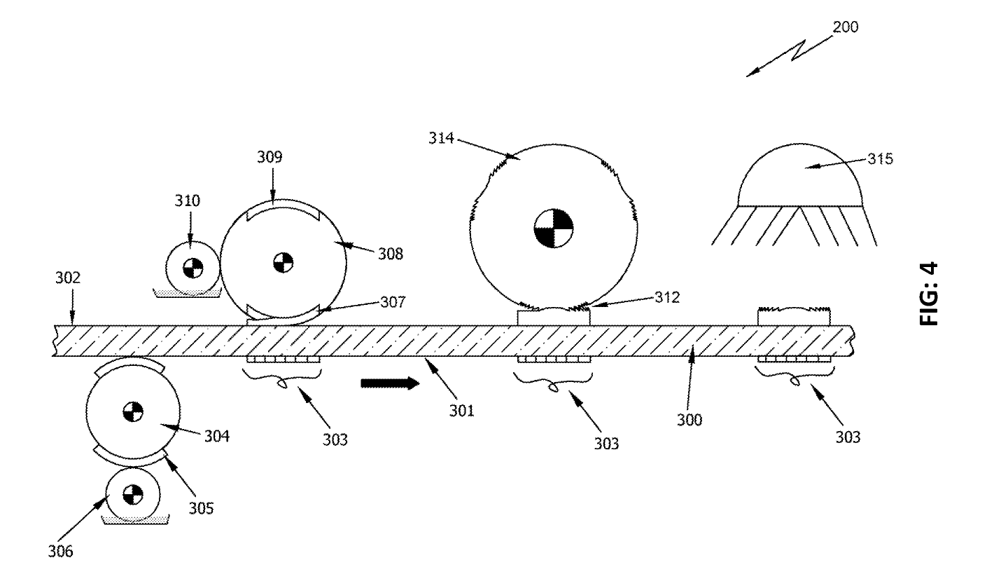

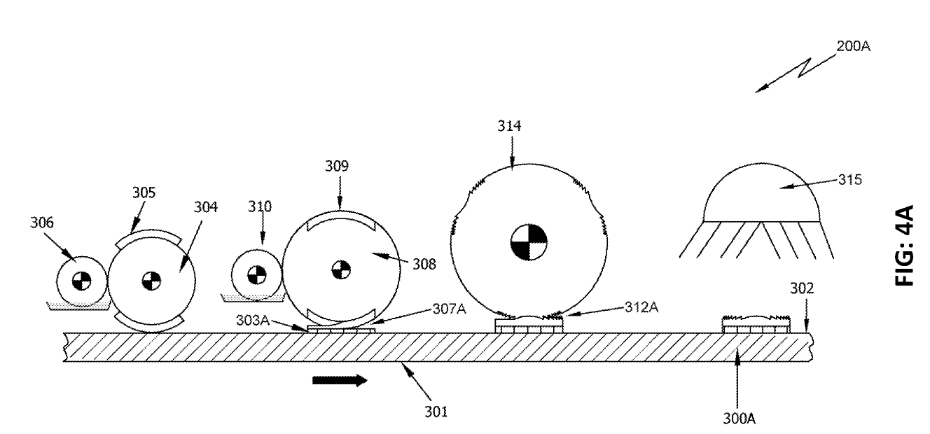

According to an embodiment of the invention, a process (200) shown in FIG. 2 is described in reference to FIG. 3 and FIG. 4 to provide an effective security/anti-counterfeit feature such as holographic images, 3-dimensional patterns, optical patterns, Fresnel lenses, sterling lenses or any similar optical features is provided on film/laminate.

At step (202), the process (200) includes providing a packaging substrate (300). The substrate (300) may include a single layer polymer film, a multilayered polymer film or laminates.

The substrate (300) may include transparent materials such as Biaxially Oriented Polypropylene (BOPP), Polyethylene terephthalate (PET), Nylon (oriented/non-oriented), Cast Polypropylene (CPP), Polyethylene (PE), EVOH or a combination thereof to achieve a single or a multi layer film substrate. The substrate (300) includes a bottom surface (301) and a top surface (302). The transparent substrates (300) is reverse printed on the bottom surface (301) as reverse printing is visible through the top surface (302). Alternatively, the substrate (300) may also be printed on top surface as well.

At step (204), the process (200) further includes selecting a desired predefined portion (303) on the substrate (300) on which a pattern is required to be made. The predefined portion (303) is a patch of predefined shape and size and is printed with high reflective ink at predefined location on the bottom surface (301) or on the top surface of the substrate (300). In an embodiment, the predefined portion (303) on the substrate (300) is positioned in relation to a reference mark (320) provided on the substrate (300). In an example, text or images or any other desired symbol is printed using a high reflective ink at predefined portion (303). The high reflective ink may include golden, silver, metallic, or the like inks to provide a shining or mirror like appearance over the printed predefined portion (303).

The process of printing high reflective ink at step (204) includes providing reverse printing on the bottom surface (301) of the substrate (300). Reverse printing is more secure as the ink in reverse printing is not exposed to the outer surface. Alternatively, surface printing on top surface may also be provided. The printing may be performed using at least one of screen printing, rotogravure printing, offset printing, Flexographic printing, Digital printing and the like.

The substrate (300) being transparent, allows shine from the reverse printed high reflective ink at the predefined portion (303) on the bottom surface (301) of the substrate (300), to be visible from the top surface (302) through the thickness of the transparent substrate (300). The surface to be printed on the substrate (300) may optionally be coated or primed, prior to the printing with high reflective ink, to increase adhesion of the high reflective ink with the substrate (300). However, un-coated or un-primed substrates may also be used. The bottom surface (301) of the substrate may be further laminated to protect the printed portion (303) or a clear protective coating or lacquer may be provided to protect the printed ink.

At step (206), after reverse printing of high reflective ink, a UV/E-beam curable coating patch (307) is provided on the top surface (302) of substrate (300) in registered overlapping the ink patch. In case of ink printing on top surface (302), the UV/E-beam curable coating patch (307) is provided registered overlapping the predefined printed portion (303) on the top surface (302).

This coating patch (307) is provided registered with respect to the reference mark (320) on the substrate (300). The reference mark (320) may be an eye mark, perforation, text, logo and the like on the substrate (300). However, when the substrate (300) is plain and unprinted, the reference mark (320) may also be printed during the ink printing process. The said reference mark (320) is used for subsequent processes of the registered embossing, printing, punching, lamination with other substrates/film & other related processes. The cast and cure process is adopted to provide the UV/E-beam curable coating patch (307) over the pre-printed high reflective ink portion (303) duly registered to fall exactly over the patch (307). The coating patch (307) is subsequently embossed at step (208) and cured at step (210). In an embodiment, the equipment for cast and cure process includes a coating cylinder (308) and a coating roller (310). The coating roller (310) transfers the coating on the coating cylinder (308) thereby filling the pre-defined coating transfer area (309) which is subsequently transferred over the substrate surface (302) in contact with the coating cylinder (308). Alternatively, the coating transfer area (309) may be replaced with flexographic plate or other suitable means for various types of coating/printing processes such as screen printing, offset printing, Digital printing or the like.

At step (208), the UV/E-beam curable coated patch (307) is embossed with holographic patterns, Fresnel lenses, sterling lenses, 3-dimensional patterns, optical patterns, or any similar optical features. In an embodiment, the embossing is performed either registered or unregistered with respect to the reference mark (320) on the substrate (300).

At least one or more of holographic patterns, Fresnel lenses, sterling lenses, 3-dimensional patterns, optical patterns, or any similar optical features are embossed using an embossing cylinder (314), registered or unregistered, on the substrate (300). The embossing (312) may be performed on a web from a roll of substrate (300) or cut sheets of the substrate (300), on flat bed or rotary embossing machine having single/multiple embossing cylinders (314), duly registered or unregistered.

In an alternate embodiment of the invention, the unregistered embossing (312) of holographic patterns, Fresnel lenses, sterling lenses, 3-dimensional patterns, optical patterns, or any similar optical features, is done, when some continuous pattern is to be embossed.

At step (210), the process (200) includes curing, which is done to provide hardness to the coated and embossed patch (307) to protect from damage by scratch, abrasion or pressure etc. Optionally a lacquer or UV/E-beam curable protective coating may be provided after curing at step (210) to further protect the embossing (312). The curing at step (210) is achieved using state of the art UV/E-beam curing unit (315).

The steps of the process (200) have been described sequentially above. However, the step (204) of reverse printing high reflective ink may be performed at any step in the process (200).

According to another embodiment of the invention, a process (200A) shown in FIG. 2A is described in reference to FIGS. 3 and 4A to provide effective security/anti-counterfeit feature such as at least one of holographic images, Fresnel lenses, sterling lenses, 3-dimensional patterns, optical patterns, or any similar optical features is provided on opaque substrate.

At step (202A), the process (200A) includes providing an opaque packaging substrate (300A). The substrate (300A) may include opaque materials like foils, paper or paperboard, which may be coated or uncoated, woven or non-woven substrate of manmade fibres of natural or polymeric origin, or any other suitable polymer or laminate. The paper may be selected from, but not limited to, bank cheque paper, currency paper, bond paper, book paper, kraft paper, wall paper, cotton paper, fish paper, inkjet paper, laid paper, leather paper, washing, wove paper polymers which are opaque or a laminate including two or more of these can also be used.

The process (200A) is for providing an effective security/anti-counterfeit feature such as holographic images, 3-dimensional patterns, optical patterns, Fresnel lenses, sterling lenses or any similar optical features on a selected predefined portion (303A) of the opaque substrate (300A). The substrate (300A) includes a top surface (302A) and a bottom surface (301A). The predefined portion (303A) is a patch of predefined shape and size on which high reflective ink is configured to be printed at predefined location on the top surface (302A) of the opaque substrate (300A). The process (200A) is almost same as the process (200) described earlier in reference to the transparent substrate (300). The basic difference between the transparent substrate (300) and the opaque substrate (300A) is that the opaque substrate (300A) can only be surface printed since there is no visibility through the thickness of the substrate (300A).

At step (204A), the process (200A) further includes selecting a desired predefined portion (303A) on the substrate (300A) on which a pattern is required to be made. The predefined portion (303A) is a patch of predefined shape and size configured to be printed with high reflective ink at predefined location on the top surface (302A) of the substrate (300A). In an embodiment, the predefined portion (303A) on the substrate (300A) is positioned in relation to a reference mark (320A) provided on the substrate (300A). In an example, text or images or any other desired symbol is printed using a high reflective ink at predefined portion (303A). The high reflective ink may include golden, silver, metallic, or the like inks to provide a shining or mirror like appearance over the printed predefined portion (303A).

The process of printing high reflective ink at step (204A) includes providing printing on the top surface (302A) of the substrate (300A). The printing may be performed using at least one of screen printing, rotogravure printing, offset printing, Flexographic printing, Digital printing and the like.

The substrate (300A) can only be printed on the top surface (302A) as printing other bottom surface (301A) will not be visible from top surface (302A) due to opacity. The surface to be printed on the substrate (300) may optionally be coated or primed, prior to the printing with high reflective ink, to increase adhesion of the high reflective ink with the substrate (300A). However, un-coated or un-primed substrates may also be used.

At step (206A), after printing of high reflective ink on the top surface (302A) of the substrate (300A), a UV/E-beam curable coating patch (307A) is provided registered overlapping the predefined printed portion (303A) on the top surface (302A).

This coating patch (307A) is provided registered with respect to the reference mark (320A) on the substrate (300A). The reference mark (320A) may be an eye mark, perforation, text, logo and the like on the substrate (300A). However, when the substrate (300A) is plain and unprinted, the reference mark (320A) may also be printed during the ink printing process. The said reference mark (320A) is used for subsequent processes of the registered embossing, printing, punching, lamination with other substrates/film & other related processes. The cast and cure process is adopted to provide the UV/E-beam curable coating patch (307A) over the pre-printed high reflective ink portion (303A) duly registered to fall exactly over the patch (307A). The coating patch (307A) is subsequently embossed at step (208A) and cured at step (210A). In an embodiment, the equipment for cast and cure process includes a coating cylinder (308) having a coating transfer area (309). The coating roller (310) transfers the coating on the coating cylinder (308) filling the pre-defined coating transfer area (309) which is subsequently transferred over the substrate surface (302) in contact with the coating cylinder (308). Alternatively, the coating transfer area (309) may be replaced with flexographic plate or other suitable means for various types of coating/printing processes such as screen printing, offset printing, Digital printing or the like.

At step (208A), the UV/E-beam curable coated patch (307A) is embossed with holographic patterns, Fresnel lenses, sterling lenses, 3-dimensional patterns, optical patterns, or any similar optical features. In an embodiment, the embossing is performed either registered or unregistered with respect to the reference mark (320A) on the substrate (300A).

At least one or more of holographic patterns, Fresnel lenses, sterling lenses, 3-dimensional patterns, optical patterns, or any similar optical features are embossed using an embossing cylinder (314), registered or unregistered, on the substrate (300A). The embossing (312) may be performed on a web from a roll of substrate (300A) or cut sheets of the substrate (300A), on flat bed or rotary embossing machine having single/multiple embossing cylinders (314), duly registered or unregistered.

In an alternate embodiment of the invention, the unregistered embossing (312) of holographic patterns, Fresnel lenses, sterling lenses, 3-dimensional patterns, optical patterns, or any similar optical features, is done, when some continuous pattern is to be embossed.

At step (210A), the process (200A) includes curing, which is done to provide hardness to the coated and embossed patch (307A) to protect from damage by scratch, abrasion or pressure etc. Optionally a lacquer or UV/E-beam curable protective coating may be provided after curing at step (210A) to further protect the embossing (312). The curing at step (210A) is achieved using state of the art UV/E-beam curing unit (315).

Further, the operation of the steps of the process (200, 200A) of high reflective ink printing and printing of UV/E-beam curable coating, embossing and curing can be performed in line on single equipment or a substrate (300, 300A) pre-printed with high reflective ink can be provided to separate equipment like cast & cure to perform the subsequent steps.

It may be contemplated that the substrates (300/300A)/film with holographic images, 3-dimensional patterns, optical patterns, Fresnel lenses, sterling lenses or any similar optical features obtained by any of the processes as described herein may be further used to make various products like pouches, bags, sachets, semi rigid or rigid cartons, display boards, wall/floor coverings, squeeze tubes of laminates, decorative laminates for household goods and many other packaging and other applications.

According to further embodiment, a flexible package (500/500A) having the integrated visual/security features—the embossing (312/312A) as described above, on at least one of its side or faces is disclosed. To adjust the position of the integrated features the position of the patch is required to be adjusted on the substrate (300, 300A) accordingly. The flexible package (500/500A) can be made from at least one or in combination(s) of the substrate (300/300A) as described hereinbefore. In an alternative embodiment, the package (500/500A) may be a semi-rigid or rigid package. The operations for the formation of various types of package are available in the prior art and further operations are not claimed hence not mentioned for sake of brevity.

The processes (200) or (200A) as explained in reference the present invention involves a simple operations which do not require special equipment. The present invention eliminates intermediate products and processes such as manufacturing and using stamping foils avoiding wastage of carrier films. This result in high speed operation with accurate registration for packaging substrate in web roll form or in sheet form. The present invention offers an innovative process for making packaging substrate to produce packages that addresses all the issues mentioned above in the prior art. The process includes printing of high reflective ink that offers metallic mirror like luster in silver, gold or any other shade. The printing may be done all over the surface of flexible packaging substrate, or at a pre-defined location. The printing includes a defined shaped and size, registered with respect to a reference mark, or printing in case the flexible packaging substrate is pre-printed. The operation is performed in roll to roll or in sheet form.

The processes (200) or (200A) as explained in reference the present invention does not involve the step of transfer by cold or hot stamping using a stamping foil over the substrates (300/300A). Hence, wastage occurring due to scrapping of the carrier film of used stamping foil has been avoided in the present invention. Further, inclusion of high reflective ink has enabled avoidance of the metallization process necessary in the manufacturing of stamping foil. Further, the high reflective ink can be printed at any pre-defined localized portion over the substrate (300/300A) which was not possible with the conventional metallization process. Special methods require metallization and then de-metallization steps to achieve such predefined portions, thereby decreasing the overall efficiency of the system and increasing overall cost. Moreover such process is not possible on paper or paper board. Due to avoidance of the stamping foil and the metallization step in the present invention, overall efficiency and productivity of the process has increased in view of reduced wastages, higher line speeds, decreased cost, as no special equipment and environments are required to conduct the conventional process, and known state of the art machines can be utilized to achieve better results with higher yields in a cost effective manner.

The foregoing descriptions of specific exemplary embodiments of the present invention have been presented for purposes of illustration and description only. They are not intended to be exhaustive or to limit the invention to the precise forms and sequence of steps disclosed, and obviously many modifications and variations are possible in light of the above teachings. The exemplary embodiments were chosen and described in order to explain certain principles of the invention and their practical application, thereby enabling others skilled in the art to make and utilize various exemplary embodiments of the present invention, as well as various alternatives and modifications thereof.

1. A process of providing selective printing and embossing of visual effect/security features on a transparent packaging substrate (300), the process comprising:
providing a substrate (300) of single layer/multilayer/laminate;
printing on a predefined portion (303) of a desired shape and size with high reflective ink at predefined location on the bottom surface (301) of the transparent substrate (300);
providing a registered UV or E-beam curable coating patch (307) overlapping the printed portion (303) on the top surface (302) of the substrate (300);
providing a registered/unregistered embossing of the visual effect/security features on the UV/E-beam curable coating patch (307), and
curing the UV/E-beam curable coating patch after embossing.

2. The process as claimed in claim 1, wherein the substrate (300) is one of a single layer polymer, a multi-layered polymer, or multi-layered laminate.

3. The process as claimed in claim 1, wherein the substrate (300) is a roll of continuous web.

4. The process as claimed in claim 1, wherein the substrate (300) is in the form of individual cut sheets.

5. The process as claimed in claim 1, wherein the substrate (300) is one of Biaxially Oriented Polypropylene (BOPP), Polyethylene terephthalate (PET), EVOH, Nylon (oriented/non-oriented), Cast Polypropylene (CPP), Polyethylene (PE), or a combination thereof.

6. The process as claimed in claim 1, wherein printing of the predefined portion (303) and UV coating patch (307) both are performed on same surface of the substrate.

7. The process as claimed in claim 1, wherein the high reflective ink includes at least one of golden ink, silver ink, metallic ink or a combination thereof to provide a shining and mirror like appearance over the predefined portion (303).

8. The process as claimed in claim 1, wherein the substrate (300) is provided with a primer coating before printing to increase adhesion and stability of the high reflective ink over surface of the substrate (300).

9. The process as claimed in claim 1, wherein the visual effect/security features is at least one of a holograms, 3-dimensional patterns, optical patterns, Fresnel lenses, sterling lenses, or a combination thereof.

10. A process of providing selective printing and embossing of visual effect/security features on an opaque packaging substrate (300A), the process comprising:
providing the opaque packaging substrate (300A);
printing on a predefined portion (303A) of a desired shape and size with high reflective ink at predefined location on top surface (302A) of the opaque substrate (300A);
providing a registered UV or E-beam curable coating patch (307A) overlapping the printed portion (303A) on the top surface (302A) of the substrate (300);
providing a registered/unregistered embossing of the visual effect/security features on the UV/E-beam curable coating patch (307A); and
curing the UV/E-beam curable coating patch after embossing.

11. The process as claimed in claim 10, wherein the opaque packaging substrate (300A) is one of polymeric monolayer or multilayer film or laminate foil, paper, woven or non-woven fibrous substrate or a combination thereof.

12. The process as claimed in claim 10, wherein the high reflective ink includes at least one of golden ink, silver ink, metallic ink or a combination thereof to provide a shining and mirror like appearance over the predefined portion (303A).

13. The process as claimed in claim 10, wherein the visual effect/security features is at least one of a holograms, 3-dimensional patterns, optical patterns, Fresnel lenses, sterling lenses, or a combination thereof.

14. A substrate (300, 300A) prepared by the process claimed in claim 1, the substrate comprising—
a bottom surface (301, 301A),
a top surface (302, 302A),
a visual effect/security feature such as holograms, 3-dimensional patterns, optical patterns, Fresnel lenses, sterling lenses on a predefined portion (303, 303A) on at least one of its surface (301, 302).

15. A package (500/500A) made from substrate (300, 300A) as claimed in claim 14 having visual effect/security feature (312, 312A) such as holograms, 3-dimensional patterns, optical patterns, Fresnel lenses, sterling lenses on at least one of its surface at predefined location or randomly place or all over the package surface.
